(19) United States
(12) Patent Application Publication
(10) Pub. No.: US 2005/0108641 A1
(43) Pub. Date: May 19, 2005

(54) Inline representation of steps in a multi-stepped process

(75) Inventors: Terry Michael Bleizeffer, Durham, NC (US); Michael Peter Etgen, Cary, NC (US); Prasad Magadi Kashyap, Apex, NC (US); Theresa Diane Ramsey, Durham, NC (US); Renee Lavonne Schwartz, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/712,467

(22) Filed: Nov. 13, 2003

(51) Int. Cl. G06F 3/00

(52) U.S. Cl. 715/700

(57) ABSTRACT

A user interface with inline representation of steps in a multi-stepped process. Each step of a given task is presented as a concise, but meaningful description. When a step is selected or “open,” the step content is displayed inline within the series of steps. This user interface with inline representation of steps in a multi-stepped process may be accomplished using a Java Server Page with a Struts framework and a Tiles framework.

### BACKGROUND OF THE INVENTION

1. Technical Field

The present invention relates to data processing systems and, in particular, to user interfaces for performing multi-stepped processes. Still more particularly, the present invention provides a method, apparatus, and program for inline representation of steps in a multi-stepped process.

2. Description of Related Art

A user interface is a combination of windows, fields, and controls, which creates a way for a user to interact with a computer. A user interface may present information to be gathered to complete a given task, such as ordering merchandise online or setting the properties of a file. An example of a user interface is a dialog box, which is a movable window that is displayed on the screen in response to a user input. A dialog box may provide a current status and available options for a particular feature in a program, for example.

At times, a user must satisfy multiple steps to perform a given task. A wizard is a user interface that guides the user through a series of steps to accomplish a task. Typically, a wizard is a series of dialogs where a user completes a step by providing required information and selects a control, such as a “next” button to proceed to the next step.

Known solutions for representing complex multi-stepped processes generally provide a poor overview of the steps required. In the simple wizard solution, the user only knows the current step with no context. In other words, the preceding or remaining steps are typically not clearly communicated or represented at all. The user typically cannot revisit content that was available in earlier steps without losing the context of the current step or, even worse, losing work completed in the current step.

### SUMMARY OF THE INVENTION

The present invention recognizes the disadvantages of the prior art and provides an improved user interface with inline representation of steps in a multi-stepped process. A task to be performed may belong to a set of tasks and consists of a series of steps. Each step of a given task is presented as a concise, but meaningful description. When a step is selected or “open,” the step content is displayed inline within the series of steps. This user interface with inline representation of steps in a multi-stepped process may be accomplished using a Java Server Page with a Struts framework and a Tiles framework.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are block diagrams illustrating a data processing system for inline representation of steps in a multi-stepped process in accordance with an exemplary embodiment of the present invention;

FIG. 5 is an example user interface window layout in accordance with a preferred embodiment of the present invention;

FIGS. 6A and 6B depict example user interface windows in accordance with an exemplary embodiment of the present invention; and

FIG. 7 is a flowchart illustrating the operation of a user interface for representing steps in a multi-stepped process in accordance with a preferred embodiment of the present invention.

### DETAILED DESCRIPTION OF THE PREFERRED EMBODIMENT

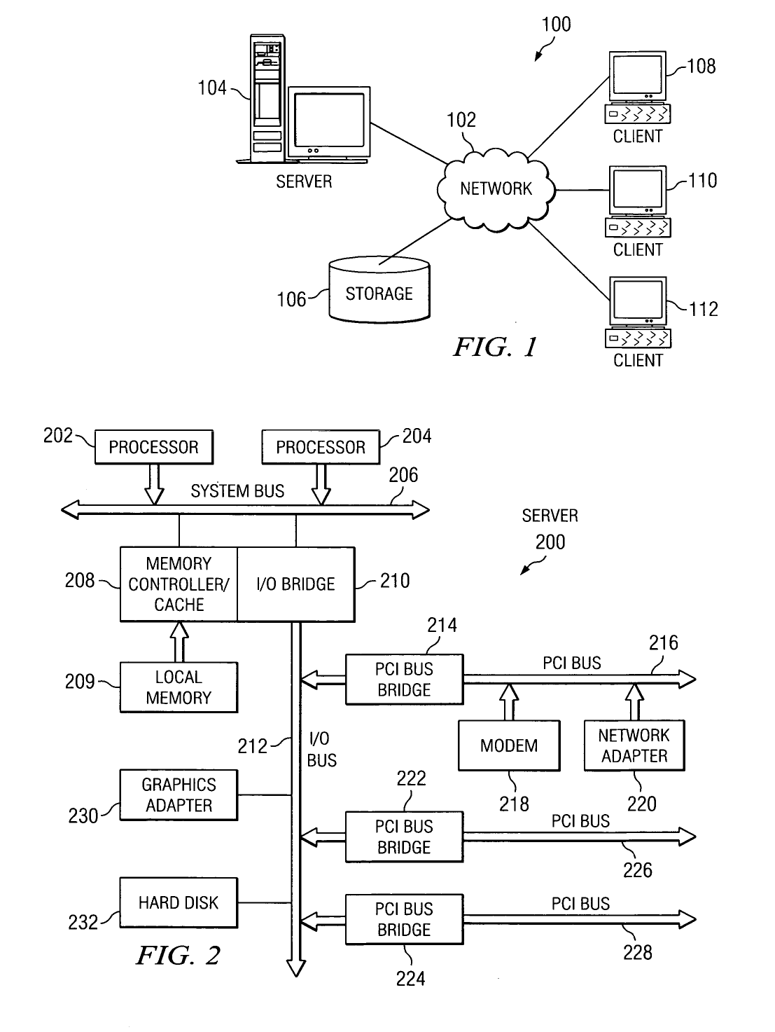

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as user interface pages and content to clients 108-112. Clients 108, 110, and 112 are clients to server 104. Network data processing system 100 may include additional servers, clients, and other devices not shown.

In accordance with a preferred embodiment of the present invention, a user of one of clients 108-112 may be performing a multi-stepped task or process. A user interface presenting a series of steps for the multi-stepped process may be presented on a display of the client device. According to a preferred embodiment of the present invention, the content of a step that is currently selected or “open,” is presented inline within the series of steps.

In an exemplary embodiment, server 104 may provide the user interface screens or “pages” to the client device. Server 104 may include a Java Server Page (JSP), which provides the user interface to the client as a HyperText Markup Language (HTML) page. JSP is an extension to the Java servlet technology from Sun Microsystems that provides a simple programming vehicle for displaying dynamic content on a Web page. The JSP is an HTML page with embedded Java source code that is executed in the Web server or application server. The HTML provides the page layout that will be returned to a Web browser of the client, and the Java provides the processing. The JSP can also call Enterprise JavaBeans (EJBs) for additional processing. JSPs are the Sun/Java counterpart to Microsoft's ASPs (Active Server Pages). A person of ordinary skill in the art will recognize that other techniques for presenting dynamic content, such as ASPs, may also be used within the scope of the present invention.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

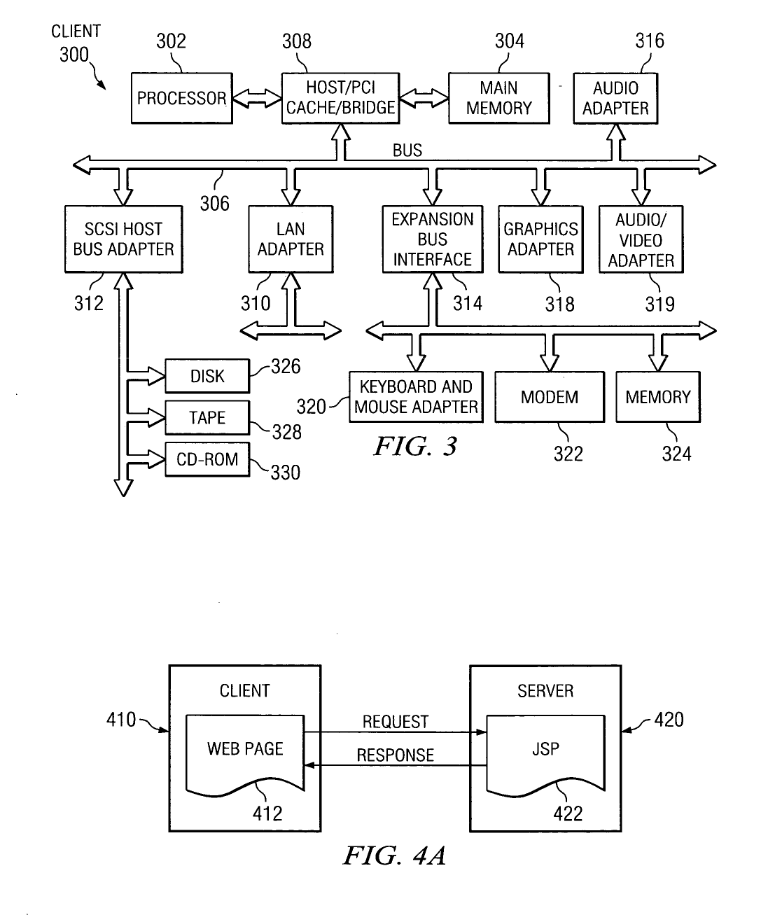

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

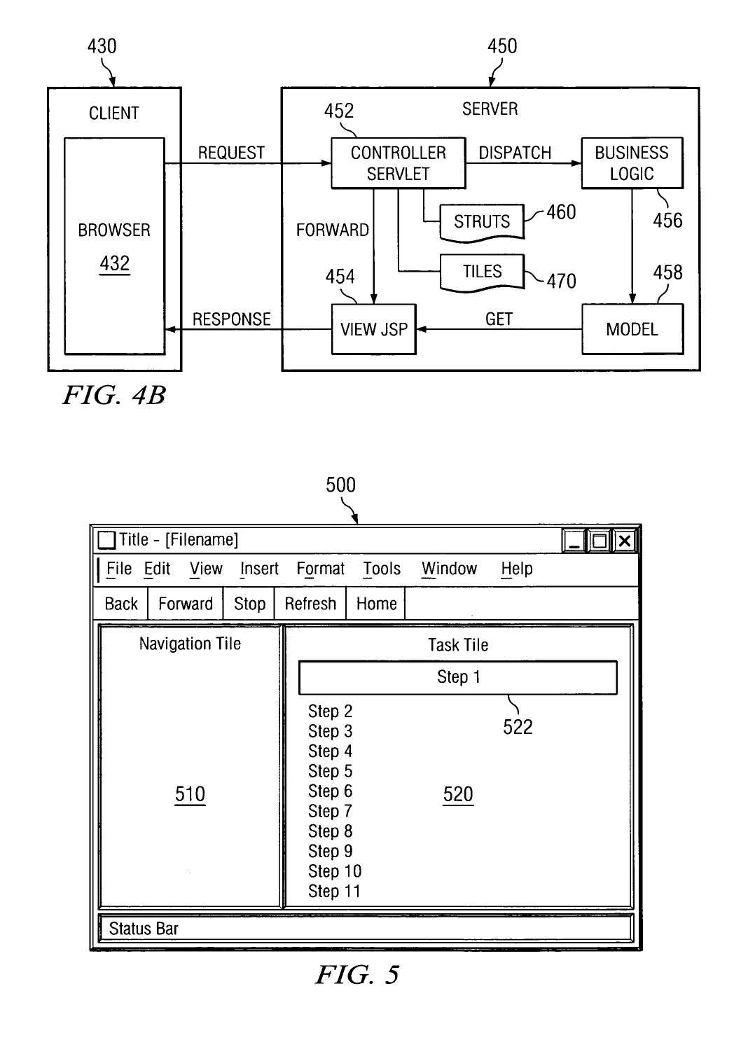

FIGS. 4A and 4B are block diagrams illustrating a data processing system for inline representation of steps in a multi-stepped process in accordance with an exemplary embodiment of the present invention. More particularly, FIG. 4A illustrates a client/server environment using a JSP implementation. Each time a user selects a task or step or completes a step of the process, client 410 makes a request to server 420 to update the user interface. In an exemplary embodiment, the request is a HyperText Transfer Protocol (HTTP) “get” request and the response is an HTML page to be presented to the user.

Client 410 may be a client device or a client application, such as a Web browser application. Similarly, server 420 may be a server device, such as server 104 in FIG. 1, or a server application, such as a Web server application. For example, server 420 may be a separate device or may be software residing on the same machine as client 410.

In an exemplary embodiment of the present invention, server 420 includes Java Server Page 422, which is a HTML page with embedded Java source code that is executed in the server. The HTML provides the page layout that will be returned to the client and the Java code provides the processing. JSP 422 dynamically generates the user interface page to include a series of steps wherein a currently selected or open step is expanded and displayed inline within the series of steps.

Turning now to FIG. 4B, a JSP implementation using Struts and Tiles is shown in accordance with an exemplary embodiment of the present invention. Struts is a framework for developing Web applications using JSP technology. Struts provides a flexible control layer based on standard technologies, such as servlets, JavaBeans, eXtensible Markup Language (XML), and an application architecture design based on a variation of a Model-View-Controller (MVC) design. Struts provides its own Controller component and integrates with other technologies to deliver the Model and View components.

Tiles is a framework that allows users to provide a consistent user interface. The Tiles framework allows users to display portions or “components” of content within a larger page of content, and to download and process just one section of the interface at a time, thus decreasing bandwidth needs. These content components, which are typically rectangular boxes of content, are reusable and may be used in recursive or nested fashion. Through a central XML file that defines the screens and sets of tags that can be embedded in JSP pages for the insertion of dynamic/static content, Tiles lets users build component views and assemble these views to form the interface pages.

Each time a user selects a task or step or completes a step of the process, client 430 makes a request to server 450 to update the user interface. In an exemplary embodiment, the request is an HTTP “get” request and the response is an HTML page to be presented to the user.

Client 430 may be a client device or a client application, such as a Web browser application. Similarly, server 450 may be a server device, such as server 104 in FIG. 1, or a server application, such as a Web server application. For example, server 450 may be a separate device or may be software residing on the same machine as client 430.

In an exemplary embodiment, client 430 includes browser 432 through which the user views the user interface pages, selects tasks and steps, and interacts with the content of the steps to complete the process. Browser 432 issues a request, which is received by controller 452 in the server. Controller 452 then makes the decision where to send the request. With Struts, the controller is a command design pattern implemented as a servlet. Struts configuration file 460, which may typically be an XML file configures the controller.

The Tiles framework provides a template mechanism that allows the responsibilities of layout to be separated from those of content. The Tiles framework provides a superset of the template tag library of Struts, as well as many other features. Tiles supports tile and layout reuse. Tiles configuration file 470, which may be an XML file, provides definitions for the layout of the user interface pages.

Business logic 456 updates the state of the model and helps control the flow of the application. With Struts, this is done with an Action class as a thin wrapper to the actual business logic. Model 458 represents the state of the application. The business objects update the application state. An ActionForm bean may be provided in model 458 to represent the Model state at a session or request level and not at a persistent level. A backend (not shown) may be provided for persistent storage of the model state.

View 454 may simply be a JSP file. The JSP file may read information from model 458 using JSP tags. View 454 dynamically generates response pages and returns them to browser 432. In accordance with a preferred embodiment of the present invention, the contents of a current step are presented inline within the series of steps for a task. Therefore, when a user at client 430 selects a step in the user interface, server 450 dynamically generates a new user interface page wherein the selected step is presented in a tile within the context of the series of steps.

FIG. 5 is an example user interface window layout in accordance with a preferred embodiment of the present invention. Window 500 presents a user interface. In an exemplary embodiment, window 500 is a Web browser application window. However, window 500 may be a stand-alone application, such as an installation program, uninstall program, configuration program, application process, or any other multi-stepped task or process.

The user interface includes a navigation tile 510 and a task tile 520. Navigation tile 510 may present a set of tasks to be performed. Task tile 520 may present a series of steps to be performed for a current task. In accordance with a preferred embodiment of the present invention, the contents of a current step, such as step 1 522 in FIG. 5, are presented as a step tile inline with the series of steps. When a user selects another step, the user interface is updated so that contents of the selected step are presented inline within the series of steps.

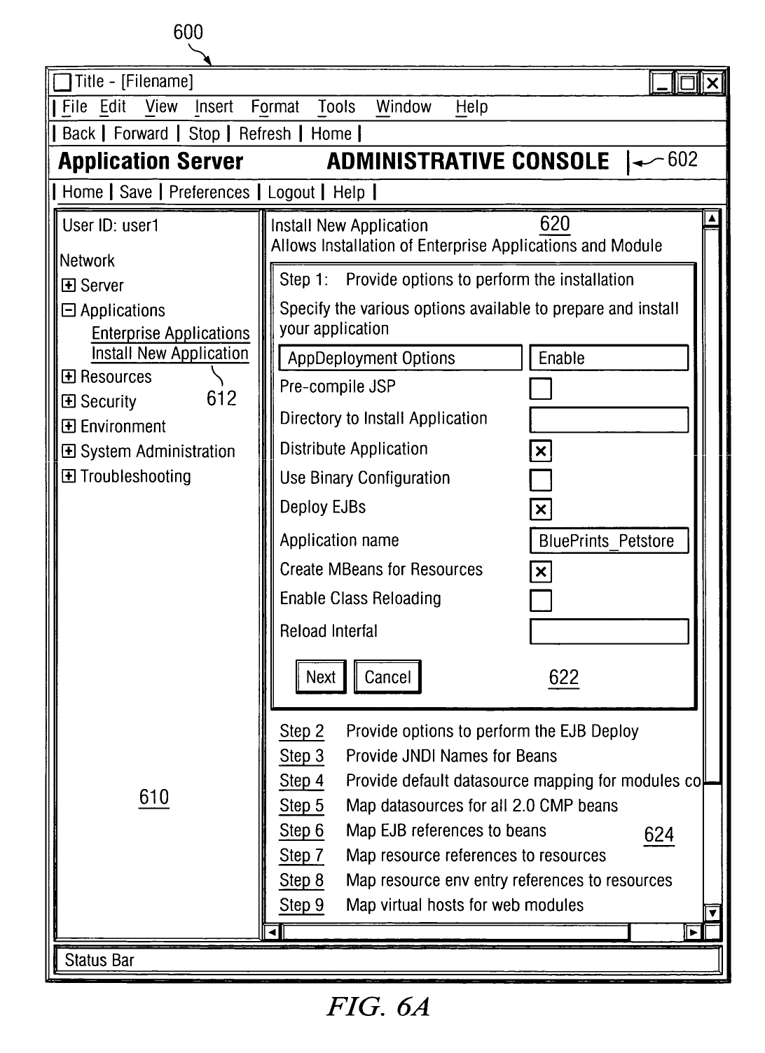

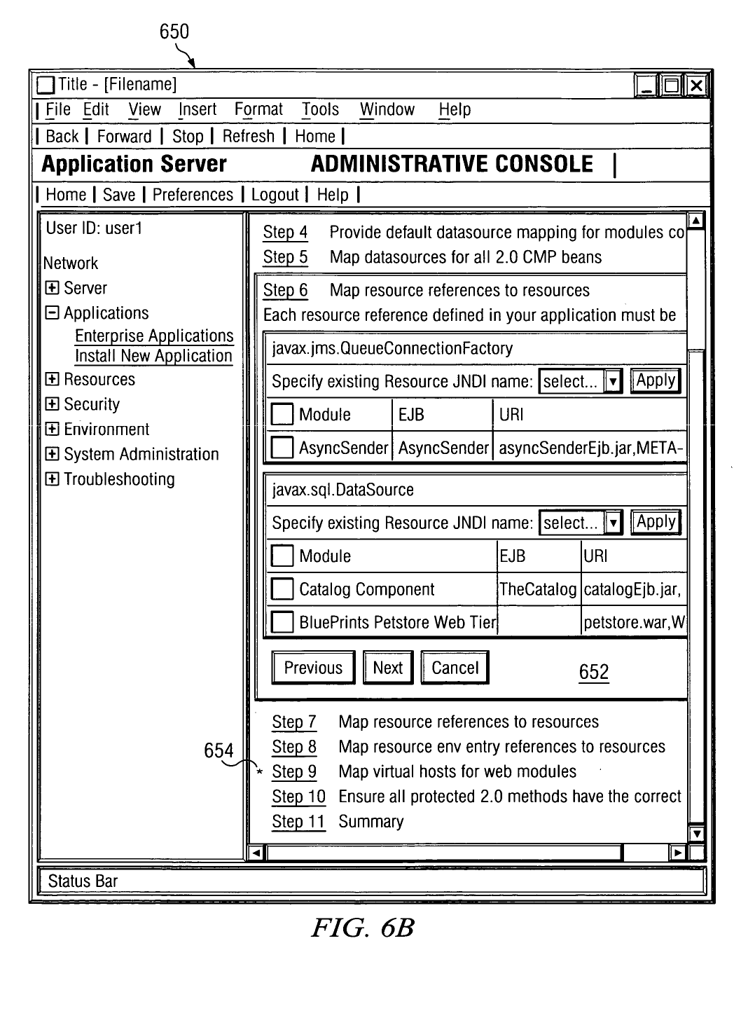

FIGS. 6A and 6B depict example user interface windows in accordance with an exemplary embodiment of the present invention. In the example shown in FIG. 6A, window 600 presents a user interface page, which includes header 602, navigation tile 610, and task tile 620. In this example, the user interface is a Web page presented in a Web browser application window.

Navigation tile 610 presents a set of tasks to be performed. For example, the set of tasks includes a plurality of server tasks, a plurality of applications tasks, a plurality of resources tasks, and so on. The set of applications tasks is expanded to show an “Enterprise Applications” task and an “Install Application” task. In the depicted example, “Install New Application” task 612 is selected.

Task tile 620 presents a series of steps for the task selected in the navigation tile. A current step, step 1 622, is open and presented within the context of remaining steps 624. Step 1 622 is presented as a tile, which may include text, tables, checkboxes, text input fields, buttons, and the like. The user may enter information for the step using the user input controls in the step tile.

When the user is finished entering information for the step, the user may select the “Next” button to proceed to the next step. The user may also select the “Cancel” button to return to a previous step or the list of steps. In addition, the steps in the series of steps 624 may be selected to proceed directly to another step. Therefore, the user may easily navigate the series of steps and enter information for a given step while still viewing the context of the series of steps.

In the example shown in FIG. 6B, window 650 presents a user interface page, where step 6 652 is open. For example, if the user selected step 6 in the series of steps 624, the user interface in FIG. 6B may be generated. Again, step 6 652 is presented as a step tile with text, tables, drop-down boxes, buttons, and checkboxes.

When the user is finished entering information for the step, the user may select the “Next” button to proceed to the next step. The user may also select the “Cancel” button to return to a previous step or the list of steps. The user may select the “Previous” button to return to the previous step. For example, pressing the “Previous” button in FIG. 6B would result in Step 5 becoming the open step. Therefore, the user may easily navigate the series of steps without having to proceed through the steps in a predefined order. The user may proceed to any desired step at any time. The user may also enter information for a given step while still viewing the context of the series of steps.

Default bindings and mappings generation may supplement missing data in the required steps. When this happens, no other user input may be required other than to jump to the last step and finish the task. Required steps with incomplete data may be shown with an asterisk or other indicator, such as indicator 654, so that the user can easily discern the steps that must be completed before finishing the task. Thus, the user may complete each and every step in succession to provide detailed input for the task or simply proceed to the required steps to more quickly complete the task.

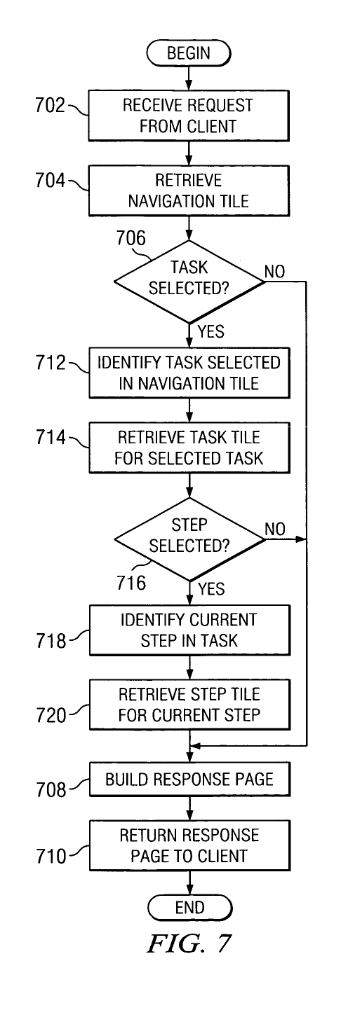

FIG. 7 is a flowchart illustrating the operation of a user interface for representing steps in a multi-stepped process in accordance with a preferred embodiment of the present invention. The process begins and receives a request from a client (step 702). The process then retrieves a navigation tile (step 704) and a determination is made as to whether a task is selected (step 706). A task may be selected as a default task when the navigation tile is first presented. In an alternative embodiment, no task may be selected when the navigation tile is first presented. A given task may be explicitly selected by a user from the navigation tile. If no task is selected, the process builds the response page (step 708) and returns the response page to the client (step 710). Thereafter, the process ends.

If a task is selected in step 706, the process identifies the task selected in the navigation tile (step 712) and retrieves a task tile for the selected task (step 714). A determination is made as to whether a step is selected in the task tile (step 716). A step may be selected as a default step when the task tile is first presented. For example, the first step may be selected by default. In an alternative embodiment, no step may be selected when the task tile is first presented. A given step may be explicitly selected by a user from the navigation tile or may be selected by selecting a “Next” or “Previous” button or control in a step tile. If no step is selected, the process builds the response page with the series of steps being presented in the task tile (step 708) and returns the response page to the client (step 710). Thereafter, the process ends.

If a step is selected in step 716, the process identifies a current step in the task (step 718) and retrieves a step tile for the current step (step 720). Then, the process builds the response page with the current step displayed inline in the task tile (step 708). The process then returns the response page to the client (step 710) and ends.

Thus, the present invention solves the disadvantages of the prior art by providing an improved user interface with inline representation of steps in a multi-stepped process. A task to be performed may belong to a set of tasks and consists of a series of steps. Each step of a given task is presented as a concise, but meaningful description. When a step is selected or “open,” the step content is displayed inline within the series of steps. This user interface with inline representation of steps in a multi-stepped process may be accomplished using a Java Server Page with a Struts framework and a Tiles framework.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for presenting a step of a task, wherein the task includes a series of steps to be performed, the method comprising:
identifying a current step within the series of steps;
retrieving a step component for the current step; and
presenting the current step inline within the series of steps such that the step component is presented in context within the series of steps.

2. The method of claim 1, wherein identifying a current step within the series of steps includes receiving a request from a client.

3. The method of claim 2, wherein the request from the client identifies a user selection of the current step within the series of steps.

4. The method of claim 2, wherein the request is a HyperText Transfer Protocol request.

5. The method of claim 2, wherein presenting the current step inline within the series of steps includes generating a response page using a Java Server Page.

6. The method of claim 5, wherein retrieving a step component for the current step includes retrieving the step component using a Tiles framework.

7. The method of claim 5, wherein generating a response page includes building the response page using a Struts framework.

8. The method of claim 5, wherein the response page includes a navigation tile, wherein the navigation tile presents a plurality of tasks.

9. The method of claim 8, further comprising:
identifying a current task within the plurality of tasks;
retrieving a task tile for the current task; and
presenting the task tile as a series of steps.

10. The method of claim 5, wherein presenting the current step inline within the series of steps further includes sending the response page to the client.

11. An apparatus for presenting a step of a task, wherein the task includes a series of steps to be performed, the apparatus comprising:
means for identifying a current step within the series of steps;
means for retrieving a step component for the current step; and
means for presenting the current step inline within the series of steps such that the step component is presented in context within the series of steps.

12. The apparatus of claim 11, wherein the means for identifying a current step within the series of steps includes means for receiving a request from a client.

13. The apparatus of claim 12, wherein the request from the client identifies a user selection of the current step within the series of steps.

14. The apparatus of claim 12, wherein the request is a HyperText Transfer Protocol request.

15. The apparatus of claim 12, wherein the means for presenting the current step inline within the series of steps includes means for generating a response page using a Java Server Page.

16. The apparatus of claim 15, wherein the means for retrieving a step component for the current step includes means for retrieving the step component using a Tiles framework.

17. The apparatus of claim 15, wherein the means for generating a response page includes means for building the response page using a Struts framework.

18. The apparatus of claim 15, wherein the response page includes a navigation tile, wherein the navigation tile presents a plurality of tasks.

19. The apparatus of claim 18, further comprising:
means for identifying a current task within the plurality of tasks;
means for retrieving a task tile for the current task; and
means for presenting the task tile as a series of steps.

20. The apparatus of claim 15, wherein the means for presenting the current step inline within the series of steps further includes means for sending the response page to the client.

21. A server for presenting a step of a task, wherein the task includes a series of steps to be performed, the method comprising:
a controller, wherein the controller receives a request from a client, wherein the request identifies a current step within the series of steps, and wherein the controller retrieves a step component for the current step; and
a Java Server Page, wherein the Java Server Page builds a response page and wherein the response page presents the current step inline within the series of steps such that the step component is presented in context within the series of steps.

22. The server of claim 21, wherein the controller and the Java Server Page use a Struts framework.

23. The server of claim 21, wherein the controller and the Java Server Page use a Tiles framework.

24. A computer program product, in a computer readable medium, for presenting a step of a task, wherein the task includes a series of steps to be performed, the computer program product comprising:
instructions for identifying a current step within the series of steps;
instructions for retrieving a step component for the current step; and
instructions for presenting the current step inline within the series of steps such that the step component is presented in context within the series of steps.
